(19) United States
(12) Patent Application Publication
(10) Pub. No.: US 2026/0160709 A1
(43) Pub. Date: Jun. 11, 2026

(54) PATTERN INSPECTING DEVICE AND PATTERN INSPECTING METHOD

(71) Applicant: NuFlare Technology, Inc., Yokohama-shi (JP)

(72) Inventor: Takafumi INOUE, Chigasaki-shi (JP)

(73) Assignee: NuFlare Technology, Inc., Yokohama-shi (JP)

(21) Appl. No.: 19/178,142

(22) Filed: Apr. 14, 2025

Related U.S. Application Data
(63) Continuation of application No. PCT/JP2023/036199, filed on Oct. 4, 2023.

(30) Foreign Application Priority Data
Feb. 27, 2023 (JP) 2023-028773

(51) Int. Cl. G01N 21/956; G01N 21/88; G06T 7/00

(52) U.S. Cl. CPC G01N 21/95607; G01N 21/8806; G06T 7/001; G01N 2021/95676; G06T 2207/30148

(57) ABSTRACT

An imaging mechanism is configured to obtain an inspection image based on light for a sample. A control unit is configured to maintain a state in which the light does not continue to strike a position on the sample for a period from completion of obtainment of an inspection image of a first area to start of obtainment of an inspection image of a second area. The position is a position at which the obtainment of the inspection image of the first area is completed or the obtainment of the inspection image of the second area is started. The control unit starts maintaining the state in which the light does not continue to strike the position, after the obtainment of the inspection image of the first area is completed and then a state in which the comparison circuit cannot start comparison is maintained over a first period.

### CROSS-REFERENCE TO RELATED APPLICATIONS

This application is a Continuation Application of PCT Application No. PCT/JP2023/036199, filed Oct. 4, 2023 and based upon and claiming the benefit of priority from Japanese Patent Application No. 2023-028773, filed Feb. 27, 2023, the entire contents of all of which are incorporated herein by reference.

### FIELD

Embodiments of the invention relates generally to a pattern inspecting device and a pattern inspecting method.

### BACKGROUND

In a manufacturing process of a semiconductor device, a pattern is transferred to a photosensitive material layer (resist) formed above a semiconductor substrate (also referred to as a “wafer”) using an exposure device, and a fine pattern of an insulator, or a conductor, etc., is formed through an etching process using a photosensitive material layer. For transfer, a mask or reticle is used. The mask has an original pattern of a pattern that is to be transferred to an insulator and a conductor. Formation of a fine pattern on the insulator and the conductor requires the mask to have a fine original pattern, too. For this reason, a mask inspecting device is required to detect a defect in a fine original pattern.

As an inspecting technique, a method of comparing an optical image obtained by imaging a pattern formed on a sample, such as a lithography mask or wafer, at a predetermined magnification using a magnifying optical system with design data, or comparing an optical image with another optical image obtained by imaging the same pattern on the sample is known. Examples of a pattern inspecting method include “die-to-die inspection” and “die-to-database inspection.” Die-to-die inspection makes a comparison between optical image data each piece of which is obtained by imaging the same pattern at different locations on the same mask. Die-to-database inspection inputs, into an inspection device, drawing data (design data) obtained by converting computer-aided design (CAD) data that defines a mask pattern into a device input format that is to be input into a drawing device when the pattern is drawn on the mask, generates a design image (reference image) based on the design data, and compares the reference image with an optical image obtained by imaging the pattern.

The inspecting method for such an inspecting device places a sample on a stage, and performs inspection by a light flux scanning the sample in response to the stage moving. The sample is irradiated with a light flux by a light source and an illumination optical system. Light that has transmitted through or been reflected from the sample is caused to form an image on a sensor. The image imaged by the sensor is sent, as measurement data, to a comparison circuit. The comparison circuit uses a plurality of areas defined by virtually dividing the entirety of an inspection target area in the sample. Imaging and comparison are performed for each of these areas, so that inspection images of the plurality of areas are obtained one after another and comparisons are made for the obtained inspection images one after another. The imaging and comparison may be performed simultaneously on the plurality of areas. After position alignment of images, the measurement data is compared with reference data according to an appropriate algorithm, and if they do not fall within tolerances, the pattern is determined to be defective.

The imaging of a mask herein also includes irradiating the mask with light while scanning the light, and also detecting the light that has transmitted through the mask.

### SUMMARY

Depending on the state of the pattern inspecting device, scanning with light may have to be stopped. In such a case, the light continues to strike a certain position on the sample until scanning with light is resumed. This may cause damage to the position on the sample at which light is continuously received. Note that a light source is not operable to resume emittance of light simultaneously with turning on of the light after it is turned off for a short time to stop irradiation of the sample with light.

Therefore, there is a demand for a pattern inspecting device that prevents damage to a sample caused by light continuously striking the position on the sample.

A pattern inspecting device includes a stage, a light source, an imaging mechanism, a stage control circuit, a comparison circuit, and a control unit. A sample is placed on the stage. The light source is configured to emit light toward the sample. The imaging mechanism is configured to obtain an inspection image based on the light with respect to an inspection target area in the sample. The stage control circuit is configured to control a position of the stage. The comparison circuit is configured to compare the inspection image with a reference image which is based on data describing a pattern possessed by the sample or with another inspection image, with respect to the inspection target area obtained by the imaging mechanism. The control unit is configured to maintain a state in which the light does not continue to strike a position on the sample for a period from completion of obtainment of an inspection image of a first area to start of obtainment of an inspection image of a second area within the inspection target area in the sample on the stage controlled to be at a predetermined position by the stage control circuit. The position where the state in which the light does not continue to strike is maintained is a position at which the obtainment of the inspection image of the first area in the sample is completed or a position at which the obtainment of the inspection image of the second area in the sample is started. The control unit starts maintaining the state in which the light does not continue to strike the position, after the obtainment of the inspection image of the first area in the sample is completed and then a state in which the comparison circuit is incapable of starting comparison processing is maintained over a first period.

### BRIEF DESCRIPTION OF THE DRAWINGS

FIG. 1 shows components of a pattern inspecting device according to a first embodiment.

FIG. 2 shows an example of an area in a sample that is inspected by the pattern inspecting device according to the first embodiment.

FIG. 3 shows components of a comparison circuit of the pattern inspecting device according to the first embodiment.

FIG. 4 shows a flow of inspection performed by the pattern inspecting device according to the first embodiment.

FIG. 5 shows a target of comparison made by the comparison circuit of the pattern inspecting device according to the first embodiment.

FIG. 6 shows a partial flow of operation performed during obtainment of an inspection image by the pattern inspecting device according to the first embodiment.

FIG. 7 shows a first example of a partial flow of operation performed during obtainment of the inspection image by the pattern inspecting device according to the first embodiment.

FIG. 8 shows a second example of a partial flow of operation performed during obtainment of the inspection image by the pattern inspecting device according to the first embodiment.

FIG. 9 shows a third example of a partial flow of operation performed during obtainment of the inspection image by the pattern inspecting device according to the first embodiment.

### DETAILED DESCRIPTION

Hereinafter, embodiments will be described with reference to the drawings. In an embodiment, a plurality of constituent components having substantially the same functions and configurations may be distinguished from each other by adding an additional number or letter to the end of their reference numeral.

### 1. First Embodiment

A pattern inspecting device according to a first embodiment will be described. Hereinafter, a case will be described in which the pattern inspecting device according to the first embodiment obtains an optical image using a light receiving element (photodiode) as an inspection image. However, the pattern inspecting device may obtain, as the inspection image, an electron-beam image using a scanning electron microscope (SEM). The pattern inspecting device according to the first embodiment is applicable to both die-to-die inspection and die-to-database inspection.

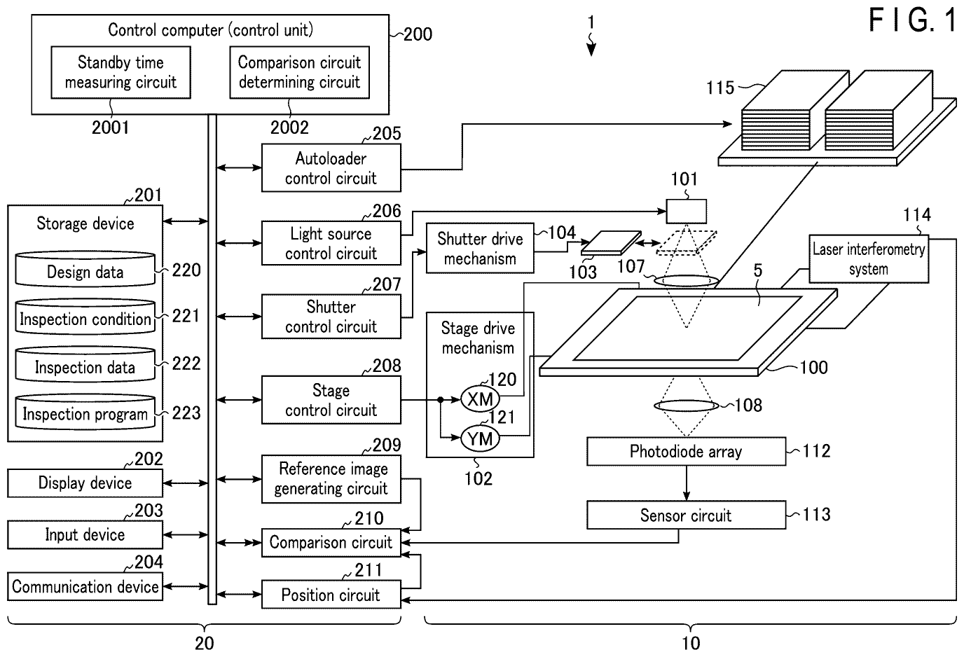

FIG. 1 shows components (a configuration) of a pattern inspecting device 1 according to the first embodiment. As shown in FIG. 1, the pattern inspecting device 1 includes an imaging mechanism 10 and a control mechanism 20.

The imaging mechanism 10 obtains an image of the sample 5 by emitting light toward a sample 5 and detecting the light having transmitted therethrough. The control mechanism 20 controls the imaging mechanism 10.

The sample 5 has a plate-like shape and has a geometric pattern (figure). Examples of the sample 5 include a mask, a wafer (a semiconductor substrate), and a substrate for use in a liquid crystal display device.

The imaging mechanism 10 includes a stage 100, a light source 101, a stage drive mechanism 102, a shutter 103, a shutter drive mechanism 104, lenses 107 and 108, a photodiode array 112, a sensor circuit 113, a laser interferometry system 114, and an autoloader 115.

The sample 5 is placed on the stage 100. While holding the sample 5 substantially horizontally, the stage 100 is movable along an x-axis and a y-axis that are parallel to the surface (the surface on which the sample 5 is placed) of the stage 100 and are perpendicular to each other. The stage 100 is further movable along a z-axis perpendicular to the surface of the stage 100. The stage 100 may further be able to rotate along the XY plane about the z-axis.

The stage drive mechanism 102 is a mechanism for moving the stage 100 along the x-axis and the y-axis. The stage drive mechanism 102 includes an x-axis motor 120 and a y-axis motor 121. The x-axis motor 120 moves the stage 100 along the x-axis. The y-axis motor 121 moves the stage 100 along the y-axis.

The light source 101 emits light. The light is, for example, ultraviolet light.

The shutter 103 can block light from the light source 101. The shutter 103 has, for example, a plate-like shape and is made of a material that absorbs light. The shutter 103 is located in an area that includes the area between the light source 101 and the lens 107 to be described later, and is movable along the x-axis and/or the y-axis. The shutter 103 is openable and closable. That is, the shutter 103 is movable along the x-axis and/or the y-axis between a position that intersects an optical path of light from the light source 101 and a position that does not intersect the optical path of light from the light source 101. While the shutter 103 is closed, the shutter 103 is located between the light source 101 and the lens 107 to block light. While the shutter 103 is open, the shutter 103 is not positioned at the position that intersects the optical path of light from the light source 101, so that the light strikes the lens 107. Meanwhile, while an image of the sample 5 is being acquired, the shutter 103 is open.

The shutter drive mechanism 104 moves the shutter 103 along the x-axis and/or the y-axis.

The lens 107 focuses light from the light source 101 onto the surface of the sample 5 (the surface facing the light source 101). The lens 107 is located between the light source 101 and the stage 100.

The lens 108 forms an image of the light having transmitted through the sample 5 onto the photodiode array 112. The lens 108 is located between the stage 100 and the photodiode array 112.

The photodiode array 112 generates an analog electrical signal based on received light. The photodiode array 112 transmits the generated electrical signal to the sensor circuit 113. Specifically, the photodiode array 112 includes an image sensor. An example of the image sensor includes a line sensor including charge-coupled device (CCD) cameras linearly arranged. Examples of the line sensor include a time delay integration (TDI) sensor.

The sensor circuit 113 converts an analog electrical signal received from the photodiode array 112 into a digital signal. The sensor circuit 113 generates data (optical image data) indicative of an optical image based on the digital signal. The sensor circuit 113 outputs the optical image data. The optical image is based on a pattern of the sample 5. The optical image expresses the brightness of each pixel, obtained by dividing the target area (imaged area) from which a corresponding optical image has been obtained, along the xy plane, as a gradation value. For example, in a case where a gradation value is represented as 8-bit data, a pixel value of each pixel has a gradation value in a range of 0 or greater and 255 and smaller. Hereinafter, the optical image of the sample 5 may be referred to as an inspection image.

The laser interferometry system 114 measures a position on the x-axis and a position on the y-axis on the stage 100. Hereinafter, the position on the x-axis and the position on the y-axis of the stage 100 may be each referred to as a stage position. The laser interferometry system 114 outputs data indicative of the stage position (stage position data).

The autoloader 115 holds a plurality of samples 5, and moves one inspection target sample 5 on a top of the stage 100. Furthermore, the autoloader 115 moves a sample 5 for which the obtainment of an inspection image has been completed from the top of the stage 100 into the autoloader 115.

The control mechanism 20 includes a control computer (control unit) 200, a storage device 201, a display device 202, an input device 203, a communication device 204, an autoloader control circuit 205, a light source control circuit 206, a shutter control circuit 207, a stage control circuit 208, a reference image generating circuit 209, a comparison circuit 210, and a position circuit 211. These are coupled to each other via a bus.

One or more of the autoloader control circuit 205, the light source control circuit 206, the shutter control circuit 207, the stage control circuit 208, the reference image generating circuit 209, the comparison circuit 210, and the position circuit 211 may be configured by a program or programs executed by the control computer (control unit) 200. That is, one or more of these circuits are realized by a program or programs being executed by the control computer (control unit) 200. The autoloader control circuit 205, the light source control circuit 206, the shutter control circuit 207, the stage control circuit 208, the reference image generating circuit 209, the comparison circuit 210, and the position circuit 211 may be realized by hardware or firmware included in the control computer (control unit) 200, or may be realized by individual circuits controlled by the control computer (control unit) 200. The following description is based on an example in which the functions of these circuits are realized based on a program or programs executed by the control computer (control unit) 200.

The control computer (control unit) 200 controls the entirety of the pattern inspecting device 1. More specifically, the control computer (control unit) 200 controls the storage device 201, the display device 202, the input device 203, the communication device 204, the autoloader control circuit 205, the light source control circuit 206, the shutter control circuit 207, the stage control circuit 208, the reference image generating circuit 209, the comparison circuit 210, and the position circuit 211.

The control computer (control unit) 200 obtains an optical image of the sample 5 by controlling the imaging mechanism 10. The control computer (control unit) 200 generates a reference image by controlling the control mechanism 20. The control computer (control unit) 200 inspects a pattern of the sample 5 by comparing the optical image with the reference image.

The control computer (control unit) 200 includes a standby time measuring circuit 2001 and a comparison circuit determining circuit 2002. The standby time measuring circuit 2001 measures a time, for example, a time from start of interruption of processing. The comparison circuit determining circuit 2002 determines whether or not the comparison circuit 210 is in a usable state.

The control computer (control unit) 200 includes, for example, a central processing unit (CPU). The CPU executes, for example, an inspection program 223 described below. The control computer (control unit) 200 may be, for example, a CPU device such as a microprocessor, or a computer device such as a personal computer. At least some of the functions of the control computer (control unit) 200 may be performed by other integrated circuits, such as an application specific integrated circuit (ASIC), a field programmable gate array (FPGA), or a graphics processing unit (GPU).

The storage device 201 stores information relating to pattern inspection. Specifically, the storage device 201 stores data such as design data 220, inspection conditions 221, inspection data 222, and the inspection program 223. The storage device 201 includes a read only memory (ROM), a random access memory (RAM), and/or a non-transitory storage medium. The storage device 201 may include, as an external storage, one or more types of storage devices such as a hard disk drive (HDD) or a solid state drive (SSD).

The inspection conditions 221 may include conditions relating to an inspection of inspection parameters, filter coefficients, etc., as well as conditions for imaging by the imaging mechanism 10.

The inspection data 222 includes the reference image, the optical image, and data relating to a detected defect. The data relating to a defect includes information such as the coordinates and size of the defect.

The inspection program 223 is a program for performing an inspection. For example, the inspection program 223 is stored by the storage device 201 using a non-transitory storage medium.

The display device 202 is a device that displays information. Examples of the display device 202 include a cathode-ray tube (CRT) display, a liquid crystal display, and an organic electroluminescence (EL) display. The display device 202 may also include a device that outputs sound.

The input device 203 is a device that receives input from an outside of the pattern inspecting device 1. Examples of the input device 203 include a keyboard, a mouse, a touch panel, and a button switch.

The communication device 204 couples the pattern inspecting device 1 to a network in order for the pattern inspecting device 1 to transmit and receive data to and from a device external to the pattern inspecting device 1. The communication device 204 may use any communication standard. For example, the communication device 204 receives design data from an external device, and transmits results of pattern inspection to the external device.

The autoloader control circuit 205 controls the operation of the autoloader 115. The autoloader control circuit 205 moves the inspection target sample 5 onto the stage 100 by operating the autoloader 115. Furthermore, the autoloader control circuit 205 moves the sample 5 from the stage 100 by operating the autoloader 115.

The light source control circuit 206 controls the light source 101.

The shutter control circuit 207 controls the shutter drive mechanism 104. Specifically, the shutter control circuit 207 moves the shutter 103 to a desired position by driving and controlling the shutter drive mechanism 104.

The stage control circuit 208 controls the stage drive mechanism 102. More specifically, the stage control circuit 208 obtains stage position data from the laser interferometry system 114 via the position circuit 211. The stage control circuit 208 drives and controls the stage drive mechanism 102 based on the stage position data.

The reference image generating circuit 209 generates a reference image based on the design data 220 describing a pattern to be formed in the sample 5. For example, the reference image generating circuit 209 receives the design data 220 from the storage device 201, loads the design data 220 into data for each pattern, and interprets a code indicative of a shape of a pattern, pattern graphic dimensions, etc., which are included in the loaded data. The reference image generating circuit 209 loads (converts) the design data 220 into a binary or multivalued (for example, 8 bits) image (loaded image) as a pattern arranged in a square in units of a predetermined grid. The reference image generating circuit 209 computes a rate at which the graphic occupies each pixel of the loaded image. The computed graphic occupation rate in each pixel functions as a gradation value for the pixel concerned. The reference image generating circuit 209 generates a reference image from a pattern of the loaded image based on the gradation value of each pixel. The reference image generating circuit 209 transmits the generated reference image to the comparison circuit 210 and the storage device 201.

The comparison circuit 210 inspects a pattern of the sample 5. That is, in a case of die-to-database inspection, the comparison circuit 210 receives data on the inspection image from the sensor circuit 113. Furthermore, the comparison circuit 210 receives, from the reference image generating circuit 209, a reference image obtained from design data defining (describing) a pattern of an area in the sample 5 from which a corresponding inspection image has been obtained. The comparison circuit 210 compares the inspection image with the reference image using an algorithm. In a case where there is a pixel in which a difference between a gradation value of the optical image and a gradation value of the reference image exceeds a preset threshold value, the comparison circuit 210 determines that a defect is present in a position on the sample 5 which corresponds to the pixel concerned. Hereinafter, a reference image obtained from design data defining a pattern of an area in the sample 5 from which a corresponding inspection image has been obtained may be referred to as a reference image “corresponding to” the inspection image.

In a case of die-to-die inspection, the comparison circuit 210 receives, from, for example, the storage device 201, an inspection image of another area that is included in the sample 5 including an area from which the inspection image has been obtained and has the same pattern as that of the aforementioned area from which the inspection image has been obtained. An obtained inspection image of an area having the same pattern as that of an area from which an inspection image has been obtained may be referred to as a comparison target image. The comparison circuit 210 compares the inspection image with the comparison target image using an algorithm. In a case where there is a pixel in which a difference between a gradation value of the optical image and a gradation value of the comparison target image exceeds a preset threshold value, the comparison circuit 210 determines that a defect is present in a position on the sample 5 which corresponds to the pixel concerned.

The position circuit 211 receives stage position data from the laser interferometry system 114 and generates, based on the stage position data, position data relating to coordinates on the x-axis and the y-axis of the stage 100.

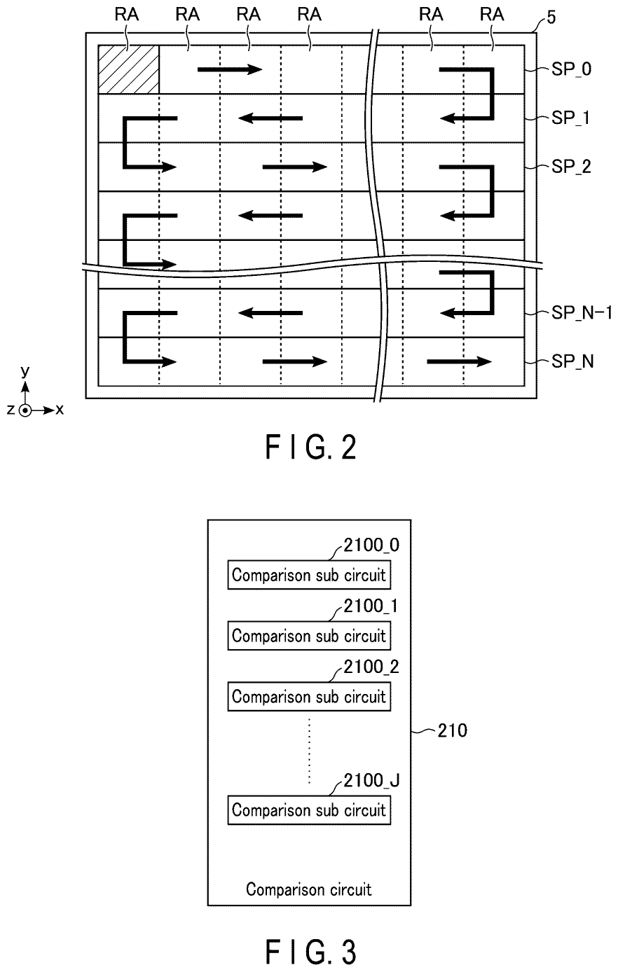

FIG. 2 shows an example of an area in the sample 5 that is inspected by the pattern inspecting device 1 according to the first embodiment. The sample 5 has a pattern (not shown). As shown in FIG. 2, the inspection target area in the sample 5 has a plurality of stripes SP and is virtually divided into the plurality of stripes SP. FIG. 2 shows an example in which the sample 5 has N+1 stripes SP_0 to SP_N. N is a positive even number. The stripes SP each have a quadrilateral shape extending along the y-axis and are distributed over the xy plane of the sample 5. The stripes SP_0 to SP_N are arranged in this order in the direction (−y direction) of smaller coordinate values on the y-axis. Each of the stripes SP extends up to the vicinities of the two ends (left and right ends) aligned along the x-axis of the sample 5. The stripes SP aligned along the y-axis are in contact with each other.

Obtainment of an image of the sample 5 is performed for each stripe SP. FIG. 2 shows an example of the order of obtaining images of the stripes SP by the thick lines. First, an image of the stripe SP_0 is obtained. Next, an image of the stripe SP_1 is obtained. Subsequently, images are obtained in the order of stripes SP_2 to SP_N in a similar manner. In a case where n is set to an integer equal to or greater than 0 and equal to or smaller than N, for example, with respect to a stripe SP_n in which n is an even number, obtainment of an image is performed in the +x direction. With respect to a stripe SP_n in which n is an odd number, obtainment of an image is performed in the −x direction. For example, each stripe SP is virtually divided into a plurality of rectangular areas RA aligned in the direction in which the stripe SP extends, and an inspection image can be generated for each of the parts corresponding to the rectangular areas RA in images obtained for the stripe SP concerned.

Changing of an area targeted for image obtainment is performed by relative movement caused by the movement of the stage 100. That is, in a case of the direction of image obtainment being the +x direction, the stage 100 moves in the −x direction, and in a case of the direction of image obtainment being the −x direction, the stage 100 moves in the +x direction.

FIG. 3 shows components of the comparison circuit 210 of the pattern inspecting device 1 according to the first embodiment. As shown in FIG. 3, the comparison circuit 210 includes J+1 comparison sub circuits 2100_0 to 2100_J where J is an integer equal to or greater than 2 and equal to and smaller than N.

The comparison sub circuits 2100 are operable independently of each other and are operable simultaneously. Each of the comparison sub circuits 2100 detects a defect by comparing the inspection image with the reference image or the comparison target image. That is, the comparison circuit 210 receives data on the inspection image from the sensor circuit 113. Furthermore, in a case of die-to-database inspection, the comparison circuit 210 receives, from the reference image generating circuit 209, a reference image obtained from design data defining a pattern of an area in the sample 5 from which a corresponding inspection image has been obtained. In a case of die-to-die inspection, the comparison circuit 210 receives the comparison target image. The comparison sub circuit 2100 compares the inspection image with the reference image or the comparison target image using an algorithm. In a case where there is a pixel in which a difference between a gradation value of the optical image and a gradation value of the reference image or the comparison target image exceeds a preset threshold value, the comparison sub circuit 2100 determines that a defect is present in a position on the sample 5 (a stage position on the x-axis and the y-axis) which corresponds to the pixel concerned.

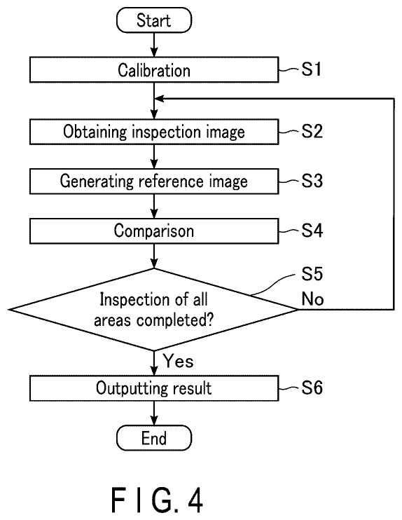

FIG. 4 shows a flow of inspection performed by the pattern inspecting device 1 according to the first embodiment. The flow of FIG. 4 is performed under control of the control computer 200. As shown in FIG. 4, the control computer 200 executes calibration by controlling the imaging mechanism 10 (S1). Through the calibration, a gradation value of the optical image to be obtained by the sensor circuit 113 is adjusted.

The control computer 200 obtains an inspection image of an inspection target area in the sample 5 (S2). The obtained inspection image is transmitted to the comparison circuit 210.

The reference image generating circuit 209 generates a reference image from the design data 220 (S3). More specifically, the reference image generating circuit 209 reads the design data 220 stored in the storage device 201 and expands the read design data 220 into the expansion image. The reference image generating circuit 209 generates a reference image from the generated expansion image. Step S3 is performed in a case of die-to-database inspection and is skipped in a case of die-to-die inspection.

The comparison circuit 210 performs comparison (S4). Specifically, the comparison circuit 210 first executes alignment between an inspection image and a reference image or a comparison target image, and then performs alignment between a pattern in the inspection image with a pattern in the reference image or the comparison target image. Next, the comparison circuit 210 compares the inspection image with the reference image or the comparison target image. The comparison circuit 210 calculates, for example, a difference in gradation value for each pixel of the inspection image and the reference image or the comparison target image, and determines that a defect is present in a pixel in which the aforementioned difference is greater than or equal to a preset threshold value.

The control computer 200 determines whether inspection has been completed for all of the inspection target areas (S5). In a case where inspection has not been completed for all of the inspection target areas (S5_No), the processing shifts to step S2. Steps S2 to S4 are performed on an area for which the inspection has not been completed.

In a case where inspection has been completed for all of the inspection target areas (S5_Yes), the processing shifts to step S6. The control computer 200 outputs a comparison result (inspection data) (S6). The control computer 200 stores the inspection result in the storage device 201. The control computer 200 causes the display device 202 to display thereon the inspection result or may output it to an external device (for example, a review device) via the communication device 204.

A plurality of sets of processing from step S2 to step S4 for the plurality of areas may be performed in parallel.

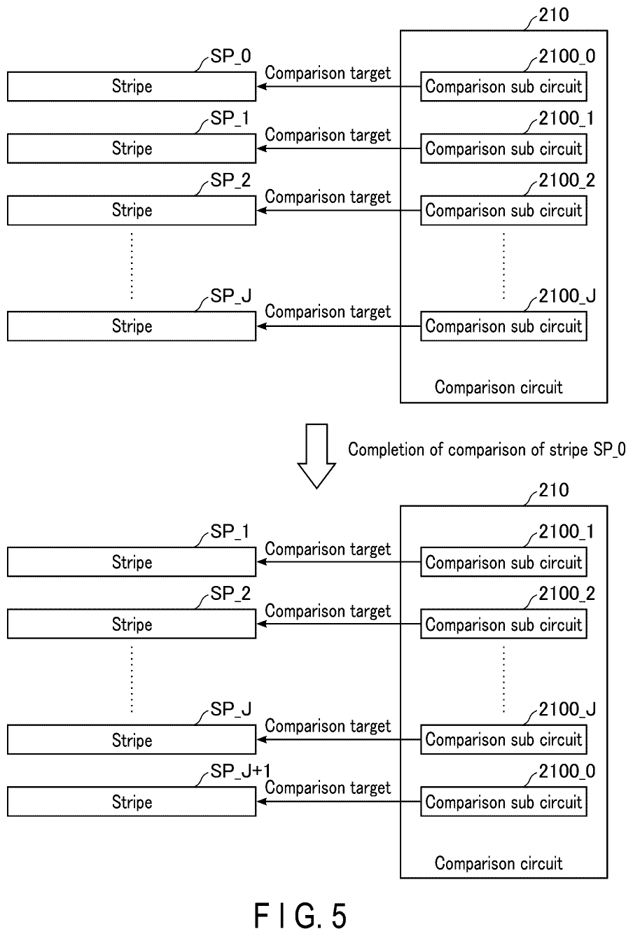

FIG. 5 shows a target of a comparison made by the comparison circuit 210 of the pattern inspecting device 1 according to the first embodiment. As shown in FIG. 5, each of the comparison sub circuits 2100 makes a comparison for a single stripe SP. The plurality of comparison sub circuits 2100 make comparisons for corresponding stripes SP, respectively, in parallel. That is, a first comparison sub circuit 2100 compares, while receiving inspection images of a plurality of rectangular areas RA in a first stripe SP as a comparison target for which the first comparison sub circuit 2100 concerned performs the comparison, each inspection image with a reference image or a comparison target image which corresponds to the inspection image concerned. Thereafter, while the first comparison sub circuit 2100 compares the inspection image with the corresponding reference image or the comparison target image for the first stripe SP, inspection images of rectangular areas RA of a second stripe SP different from the first stripe SP are acquired. Then, while the first comparison sub circuit 2100 compares the inspection image with the corresponding reference image or comparison target image for the first stripe SP, the second comparison sub circuit 2100 compares each inspection image with a corresponding reference image or comparison target image for the second stripe SP. In a similar manner, the plurality of comparison sub circuits 2100 make comparisons for corresponding stripes SP, respectively, in parallel.

Each of the comparison sub circuits 2100 transmits, upon completion of a comparison for the entirety of a stripe SP as a target of a comparison made by the comparison sub circuit 2100 concerned, a signal notifying the completion to the control computer 200. The signal notifying the completion is received by the comparison circuit determining circuit 2002. In a case where the comparison circuit determining circuit 2002 receives the signal notifying the completion from a comparison sub circuit 2100, the control computer 200 assigns this comparison sub circuit 2100 to a comparison for another stripe SP. Upon completion of a comparison for a stripe SP, a comparison sub circuit 2100 which is not assigned to any stripe SP (that is, an available comparison sub circuit 2100) is assigned to a next stripe SP. A state in which no comparison sub circuit 2100 is available corresponds to a state in which the comparison circuit 210 cannot make a comparison.

FIG. 5 shows an example of assignment of comparison sub circuits 2100 to stripes SP in the pattern inspecting device according to the first embodiment. As shown in FIG. 5, the comparison sub circuits 2100_0 to 2100_J make comparisons for stripes SP_0 to SP_J, respectively. Upon completion of a comparison for the stripe SP_0, the control computer 200 assigns the comparison sub circuit 2100_0 to a comparison for a stripe SP_J+1.

If no (free) comparison sub circuit 2100 is available when obtainment of an inspection image for a stripe SP is completed, a standby time until occurrence of an available comparison sub circuit 2100 may occur. However, by the pattern inspecting device 1 having a sufficient number of comparison sub circuits 2100, occurrence of a standby time can be prevented. That is, based on the speed of obtainment (scanning of light) of an inspection image and the speed of a comparison by each comparison sub circuit 2100, the number of the comparison sub circuits 2100 that enables a comparison sub circuit 2100 available for a next stripe SP to be present when obtainment of an inspection image of a stripe SP is completed is provided. On the other hand, it is not realistic that the number of the comparison sub circuits 2100 that enables a large margin is provided. Therefore, based on the speed of obtainment of an inspection image and the speed of a comparison by each comparison sub circuit 2100, the number of the comparison sub circuits 2100 that enables a single available comparison sub circuit 2100 to be present when obtainment of an inspection image of a stripe SP is completed is provided.

The comparison sub circuit 2100 may cause a failure or a malfunction. In such a case, a comparison sub circuit 2100 in which a failure or a malfunction occurs is not used. Instead, another comparison sub circuit 2100 is used. As a specific example, in a case where the comparison sub circuit 2100_1 is not operable, the comparison circuits 2100_2, . . . , 2100_J are respectively assigned to the stripes SP_1, . . . , SP_J−1. Upon completion of a comparison for the stripe SP_0, the comparison sub circuit 2100_0 is assigned to the stripe SP_J.

In a case where an inoperable comparison sub circuit 2100 is present, a standby time for waiting for an available (unassigned) comparison sub circuit 2100 to occur may be generated. That is, as described above, the number of the comparison sub circuits 2100 that enables an available comparison sub circuit 2100 to be present when obtainment of an inspection image of a stripe SP is completed is provided. In other words, if the comparison sub circuits 2100 in the number as described above are operable, when obtainment of an inspection image of a stripe SP is completed, obtainment of an inspection image of a next stripe SP and a subsequent comparison by an available comparison sub circuit 2100 can be started immediately. Therefore, a standby time for waiting an available comparison sub circuit 2100 to occur is not generate. On the other hand, in a case where an inoperable comparison sub circuit 2100 is present, an available comparison sub circuit 2100 is absent when obtainment of an inspection image for a stripe SP is completed. Thus, the control computer 200 suspends obtainment of an inspection image until occurrence of an available comparison sub circuit 2100.

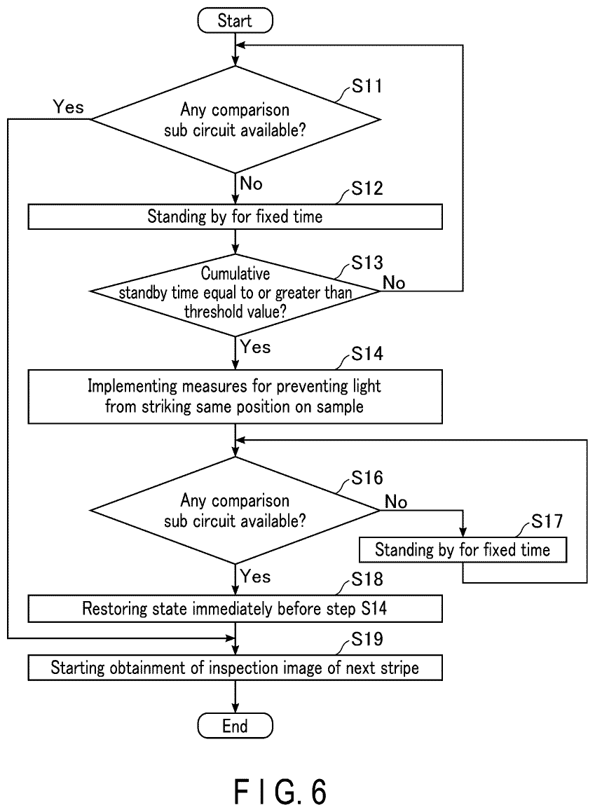

FIG. 6 shows a partial flow performed during obtainment of an inspection image by the pattern inspecting device 1 according to the first embodiment. Specifically, FIG. 6 shows a flow from completion of obtainment of an inspection image for a stripe SP to start of obtainment of an inspection image for a next stripe SP. The flow shown in FIG. 6 is started in a case where obtainment of an inspection image for a stripe SP is completed and a next stripe SP for which an inspection image is to be obtained is present. The flow shown in FIG. 6 is performed under control of the control calculator 200.

As shown in FIG. 6, upon start of the flow, the control computer 200 determines, using the comparison circuit determining circuit 2002, whether or not an available (unassigned) comparison sub circuit 2100 is present (S11). An available comparison sub circuit 2100 being present has the same meaning as the comparison circuit 210 being able to make a comparison. In a case where an available comparison sub circuit 2100 is present (S11_Yes), the control computer 200 starts obtainment of an inspection image of a next stripe SP (S19). Also, the available comparison sub circuit 2100 is assigned to a comparison of the next stripe SP. Upon completion of step S19, the flow shown in FIG. 6 is completed.

In a case where no available comparison sub circuit 2100 is present (S11_No), the control computer 200 stands by for a fixed time (S12). During step S12, for example, the control computer 200 maintains the stage 100 at a position immediately before step S12. The stage 100 does not necessarily stay at a fixed position. Along with the start of a standby, the control computer 200 starts measurement of time by the standby time measuring circuit 2001, thereby measuring a duration time of standby (a standby time).

After a standby for a fixed time as step S12, the control computer 200 determines whether or not a cumulative standby time after start of the flow shown in FIG. 6 is equal to or greater than a threshold value (S13). The cumulative standby time depends on the number of times step S12 is performed. In a case where the cumulative standby time is not equal to or greater than a threshold value (S13_No), the control computer 200 executes step S11, that is, determines whether or not an available comparison sub circuit 2100 is present. As described above, the control computer 200 repeatedly determines on a regular basis whether or not an available comparison sub circuit 2100 is present until the cumulative standby time reaches the threshold value or greater through a loop of sets of step S11, step S12, and step S13.

In a case where the cumulative standby time reaches the threshold value or greater (S13_Yes), the control computer 200 maintains a state in which light does not continue to strike the same position on the sample 5 or implements measures for preventing light from striking (S14). A specific example of step S14 will be described later. A state formed by the measures taken in step S14 continues until subsequent step S18.

The control computer 200 determines using the comparison circuit determining circuit 2002 whether or not an available comparison sub circuit 2100 is present (S16). In a case where there is no available comparison sub circuit 2100 (S16_No), the control computer 200 stands by for a fixed time (S17). For step S16, for example, the control computer 200 maintains the stage 100 at the current position without moving it. Step S17 is continuous to step S16. That is, a determination is made on a regular basis as to whether or not an available comparison sub circuit 2100 has occurred, and a state formed by the measures taken in step S14 continues until occurrence of the available comparison sub circuit 2100.

In a case where an available comparison sub circuit 2100 (S16_Yes) is present, the control computer 200 restores a state immediately before step S14 (S18). That is, the state formed by the measures taken in step S14 is terminated. Depending on the type of measures taken in step S14, step S18 is not performed, and the control computer 200 performs step S19 in a case where an available comparison sub circuit 2100 is present (S16_Yes).

The control computer 200 initiates scanning of a next stripe SP (S19). By this, the flow shown in FIG. 6 is terminated.

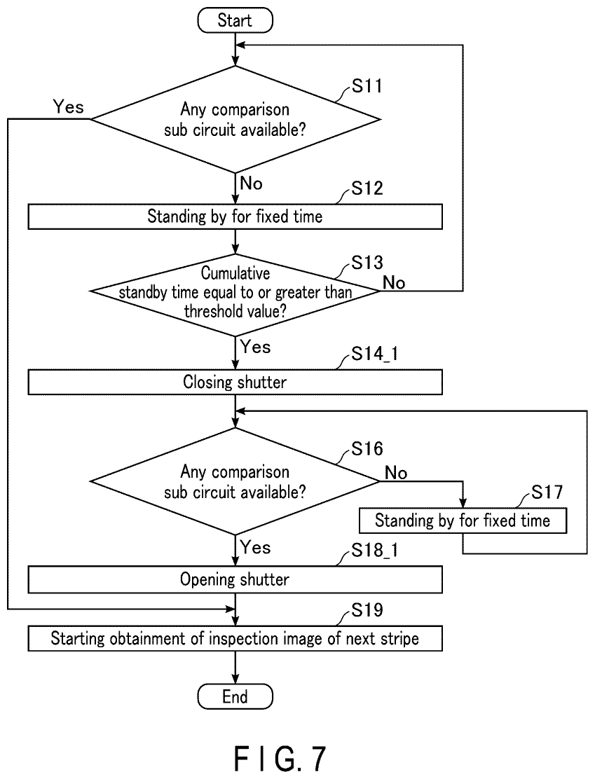

A specific example of step S14 will be described with reference to FIG. 7 to FIG. 9. FIG. 7 to FIG. 9 respectively show a first example, a second example, and a third example of the flow of the operation according to the first embodiment.

As shown in FIG. 7, in the first example, as step S14, the control computer 200 provides the shutter control circuit 207 with an instruction to close the shutter 103. Based on a content of the instruction, the shutter control circuit 207 closes the shutter 103 by controlling the shutter drive mechanism 104 (S14_1). The shutter 103 is closed over a period until an available comparison sub circuit 2100 occurs through loop of one or more sets of step S16 and step S17. By this, light does not reach the sample 5 over a period until an available comparison sub circuit 2100 occurs through a loop of one or more sets of step S16 and step S17. As step S18, the control computer 200 provides the shutter control circuit 207 with an instruction to open the shutter 103. Based on a content of the instruction, the shutter control circuit 207 opens the shutter 103 by controlling the shutter drive mechanism 104 (S18_1).

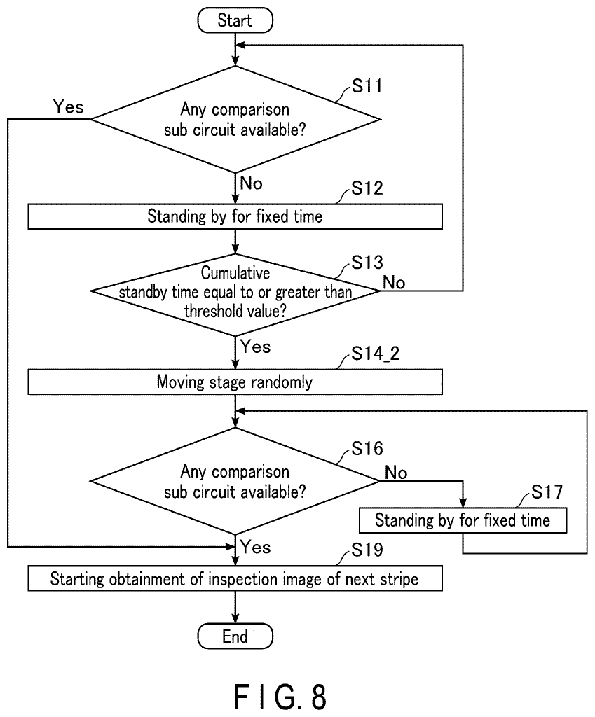

As shown in FIG. 8, in the second example, as step S14, the control computer 200 provides the stage control circuit 208 with an instruction for randomly moving the stage 100. Based on a content of the instruction, the stage control circuit 208 randomly moves the stage 100 by controlling the stage drive mechanism 102 (S14_2). For example, the control computer 200 provides an instruction for randomly moving the stage 100 inside an area with a center set to a position on the stage 100 immediately before step S14. Examples of randomly moving the stage 100 include randomly moving the stage 100 in a continuous manner and randomly moving the stage 100 in a sporadic manner for a fixed or random period. The control computer 200 provides an instruction for continuously moving the stage 100 or repeatedly moving it in a sporadic manner over a period until occurrence of an available comparison sub circuit 2100 through a loop of one or more sets of step S16 and step S17. This prevents light from striking the same position on the sample 5 over a period until occurrence of an available comparison sub circuit 2100 through a loop of one or more sets of step S16 and step S17. The second example does not perform step S18.

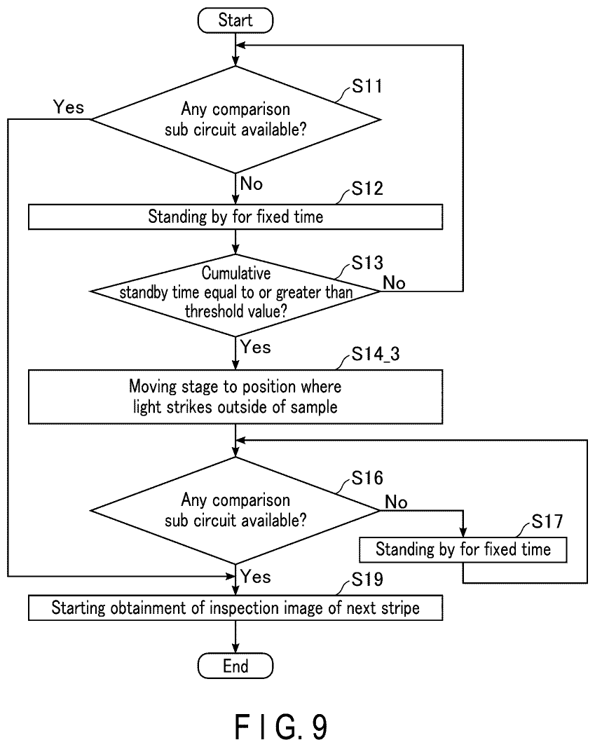

As shown in FIG. 9, in the third example, as step S14, the control computer 200 provides the stage control circuit 208 with an instruction for moving the stage 100 to a position where light strikes an outside of the sample 5. Based on a content of the instruction, the stage control circuit 208 controls the stage drive mechanism 102, thereby randomly moving the stage 100 to a position where light strikes an outside of the sample 5 (S14_3). The position on the stage is maintained over a period until occurrence of an available comparison sub circuit 2100 through a loop of one or more sets of step S16 and step S17. The third example does not perform step S18.

According to the first embodiment, damage to the sample 5 is suppressed as described below. As described with reference to FIG. 5, waiting for an available comparison sub circuit 2100 may occur. In such a case, obtainment of an inspection image of a next stripe SP cannot be started. Thus, the stage 100 cannot move to a position for obtainment of the inspection image of the next stripe SP, so that light from the light source 101 continuously strikes the sample 5 until an available comparison sub circuit 2100 occurs. This may cause damage to the sample 5. Assuming, for example, that the position on the stage 100 is simply maintained until occurrence of an available comparison sub circuit 2100, light continues to strike the same position.

In a case where a state where no comparison sub circuit 2100 is available when obtainment of an inspection image of a stripe SP is completed is continued for a fixed time or longer, the pattern inspecting device 1 according to the first embodiment maintains a state in which light does not continue to strike the same position on the sample 5. In a case where an available comparison sub circuit 2100 occurs, as needed, the control computer 200 releases such a state in which light does not continue to strike the same position on the sample 5, and starts obtainment of an inspection image of a next stripe SP. This suppresses or prevents damage to the sample 5 caused by light striking a location where striking of light is not necessary over a period until an available comparison sub circuit 2100 occurs.

### 2. Others

In the example described with reference to FIG. 1, the pattern inspecting device 1 obtains an optical image formed by light that has transmitted through the sample 5. The pattern inspecting device 1 may obtain an optical image formed by light reflected by the sample 5. Furthermore, the pattern inspecting device 1 may obtain both of the optical image formed by light reflected by the sample 5 and the optical image formed by light that has transmitted through the sample 5.

Yet further, in the example described above, the pattern inspecting device 1 obtains an optical image of the sample 5. The pattern inspecting device 1 may obtain an inspection image using electron beams. In such a case, an electron gun is included instead of the light source 101.

In the embodiments described above, descriptions for portions which are not directly required for explaining the present invention, such as detailed configurations of devices and control methods, are omitted. However, it should be noted that the configurations of the devices and the control methods can be suitably selected and used as required. All detection methods and detection apparatuses that comprise the elements of the present invention and that can be suitably modified by a person with ordinary skill in the art are encompassed in the scope of the present invention.

What is claimed is:

1. A pattern inspecting device comprising:
a stage on which a sample is placed;
a light source configured to emit light toward the sample;
an imaging mechanism configured to obtain an inspection image based on the light with respect to an inspection target area in the sample;
a stage control circuit configured to control a position of the stage;
a comparison circuit configured to compare the inspection image with a reference image which is based on data describing a pattern possessed by the sample or with another inspection image, with respect to the inspection target area obtained by the imaging mechanism; and
a control unit configured to maintain a state in which the light does not continue to strike a position on the sample for a period from completion of obtainment of an inspection image of a first area to start of obtainment of an inspection image of a second area within the inspection target area in the sample on the stage controlled to be at a predetermined position by the stage control circuit,
wherein the position where the state in which the light does not continue to strike is maintained is a position at which the obtainment of the inspection image of the first area in the sample is completed or a position at which the obtainment of the inspection image of the second area in the sample is started, and the control unit starts maintaining the state in which the light does not continue to strike the position, after the obtainment of the inspection image of the first area in the sample is completed and then a state in which the comparison circuit is incapable of starting comparison processing is maintained over a first period.

2. The pattern inspecting device according to claim 1, wherein the position where the state in which the light does not continue to strike is maintained is a position within the inspection target area in the sample.

3. The pattern inspecting device according to claim 1, further comprising a shutter locatable between the light source and the stage,
wherein the control unit controls the shutter such that the shutter is maintained between the light source and the stage during the state in which the light does not continue to strike the position on the sample.

4. The pattern inspecting device according to claim 1, wherein the stage control circuit moves the stage in a continuous manner or in a sporadic manner during the state in which the light does not continue to strike the position on the sample for which the state in which the light does not continue to strike is maintained.

5. The pattern inspecting device according to claim 1, wherein the stage control circuit maintains the stage at a position where the light continues to strike an outside of the sample during the state in which the light does not continue to strike the position on the sample for which the state in which the light does not continue to strike is maintained.

6. The pattern inspecting device according to claim 1, wherein the control unit maintains the state in which the light does not continue to strike the position on the sample for a period from completion of the obtainment of the inspection image of the first area in the sample to entry into a state in which the comparison circuit is capable of starting comparison, after a state in which the light does not continue to strike the position within the inspection target area in the sample is maintained.

7. A pattern inspecting method for a pattern inspecting device comprising:
a stage on which a sample is placed;
a light source configured to emit light toward the sample;
an imaging mechanism configured to obtain an inspection image based on the light with respect to an inspection target area in the sample; and
a comparison circuit configured to compare the inspection image with a reference image which is based on data describing a pattern possessed by the sample or with another inspection image, with respect to the inspection target area obtained by the imaging mechanism,
the method comprising:
obtaining an inspection image of a first area within the inspection target area;
maintaining a state in which the comparison circuit is incapable of starting comparison processing over a first period; and
maintaining a state in which the light does not continue to strike a position on the sample for a period after the first period and until start of obtainment of an inspection image of a second area within the inspection target area,
wherein the position where the state in which the light does not continue to strike is maintained is a position at which the obtainment of the inspection image of the first area in the sample is completed or a position at which the obtainment of the inspection image of the second area in the sample is started.

8. The pattern inspecting method according to claim 7, wherein the position where the state in which the light does not continue to strike is maintained is a position within the inspection target area in the sample.

9. The pattern inspecting method according to claim 7, wherein the maintaining of the state in which the light does not continue to strike the position on the sample includes maintaining a shutter between the light source and the stage.

10. The pattern inspecting method according to claim 7, wherein the maintaining of the state in which the light does not continue to strike the position on the sample includes moving the stage in a continuous manner or in a sporadic manner.

11. The pattern inspecting method according to claim 7, wherein the maintaining of the state in which the light does not continue to strike the position on the sample includes maintaining the stage at a position where the light continues to strike an outside of the sample.

12. The pattern inspecting method according to claim 7, further comprising maintaining the state in which the light does not continue to strike the position on the sample for a period from completion of the obtainment of the inspection image of the first area in the sample to entry into a state in which the comparison circuit is capable of starting comparison, after a state in which the light does not continue to strike the position within the inspection target area in the sample is maintained.
